(19) United States
(12) Patent Application Publication
(10) Pub. No.: US 2016/0321741 A1
(43) Pub. Date: Nov. 3, 2016

(54) SYSTEM AND METHOD OF MODULE-BASED WEBSITE DATA ORGANIZATION

(71) Applicant: Wal-Mart Stores, Inc., Bentonville, AR (US)

(72) Inventors: Huizhong Duan, Redwood City, CA (US); Abhishek Gattani, Sunnyvale, CA (US); Kuo Yu, Sunnyvale, CA (US); Ba-Quy Vuong, Foster City, CA (US)

(21) Appl. No.: 14/701,384

(22) Filed: Apr. 30, 2015

(51) Int. Cl. G06Q 30/06

(52) U.S. Cl. CPC G06Q 30/0643; G06Q 30/0625

(57) ABSTRACT

A system is provided including a user interface and a processing device. The user interface is accessible to the user and includes at least one zone configured to display a module, the at least one zone having an associated module definition. The module definition comprises a visual organization of a plurality of product-related data elements sharing at least one common attribute. The processor includes a module definition unit and a module generation unit. The module definition unit includes a plurality of module definitions and is configured to provide at least one module definition in response to the presence of the at least one zone on the user interface. The module generation unit is configured to generate a module for display within the at least one zone by collecting the product-related data from a database as a function of the module definition and the collected product-related data.

### COPYRIGHT NOTICE

A portion of this disclosure contains material that is subject to copyright protection. The copyright owner has no objection to the facsimile reproduction by anyone of this patent document as it appears in the U.S. Patent and Trademark Office, patent file or records, but reserves all copyrights whatsoever in the subject matter presented herein.

### TECHNICAL FIELD

The present invention relates to organization of website data and, more particularly, to a module-based system and method of visually organizing data sharing common attributes.

### BACKGROUND

Many retail e-commerce websites drive increased sales through active display of similar products in a visually appealing and logically understandable manner. At least some known web hosting systems generate various representations of similar products through predefined graphical displays and user interfaces. Such product displays require extensive programming and design work in order to tailor each display based on the products shown.

At least some known systems require additional processing and memory in order to account for the various ways of showing products on an e-commerce website. Because of the various ways of grouping products based on common attributes, additional system resources may be required in order to maintain predefined graphical representations of each product grouping. This not only leads to additional required system resources but also leads to additional human errors when the graphical representations are manually developed for use within a given e-commerce site.

It is an object of the present invention to address or at least ameliorate some of the above disadvantages.

### SUMMARY OF THE INVENTION

In different embodiments of the present invention, systems, methods, and computer-readable storage media allow users to organize pluralities of product-related data into visual representations for display on a website.

In one embodiment within the present disclosure, a system is provided. The system includes a user interface and a processing device in communication with the user interface. The user interface is accessible to the user and includes at least one zone configured to display a module, the at least one zone having an associated module definition. The module definition comprises a visual organization of a plurality of product-related data elements sharing at least one common attribute. The processing device includes a module definition unit and a module generation unit. The module definition unit includes a plurality of module definitions and is configured to provide at least one module definition in response to the presence of the at least one zone on the user interface. The module generation unit is configured to communicate with at least one database including a plurality of product-related data. The module generation unit is configured to generate a module for display within the at least one zone by collecting the product-related data from the database as a function of the module definition and the collected product-related data.

In another embodiment within the present disclosure, a method of using a system including a user interface and a processing device is provided. The user interface is accessible to the user and includes at least one zone configured to display a module, the at least one zone having an associated module definition. The module definition comprises a visual organization of a plurality of product-related data elements sharing at least one common attribute. The processing device includes a module definition unit and a module generation unit. The module definition unit includes a plurality of module definitions. The module generation unit is configured to communicate with at least database. The method includes the steps of: providing, through the module definition unit, the at least one module definition in response to the presence of the at least one zone on the user interface; collecting, through the module generation unit, the product-related data from the database as a function of the module definition; and generating, through the module generation unit, a module for display within the at least one zone as a function of the product-related data and the module definition.

In another embodiment within the present disclosure, a non-transitory information recording medium on which a computer readable program is recorded that causes a computer to function as a system is provided. The system includes a user interface and a processing device in communication with the user interface. The user interface is accessible to the user and includes at least one zone configured to display a module, the at least one zone having an associated module definition. The module definition comprises a visual organization of a plurality of product-related data elements sharing at least one common attribute. The processing device includes a module definition unit and a module generation unit. The module definition unit includes a plurality of module definitions and is configured to provide at least one module definition in response to the presence of the at least one zone on the user interface. The module generation unit is configured to communicate with at least one database including a plurality of product-related data. The module generation unit is configured to generate a module for display within the at least one zone by collecting the product-related data from the database as a function of the module definition and the collected product-related data.

### BRIEF DESCRIPTION OF THE DRAWINGS

Non-limiting and non-exhaustive embodiments of the present invention are described with reference to the following figures. Other advantages of the present disclosure will be readily appreciated, as the same becomes better understood by reference to the following detailed description when considered in connection with the accompanying drawings wherein:

FIG. 1 is a schematic illustrating various aspects of a system, according to the present disclosure;

FIG. 2 is a schematic illustrating example components of a server, according to an embodiment of the present invention;

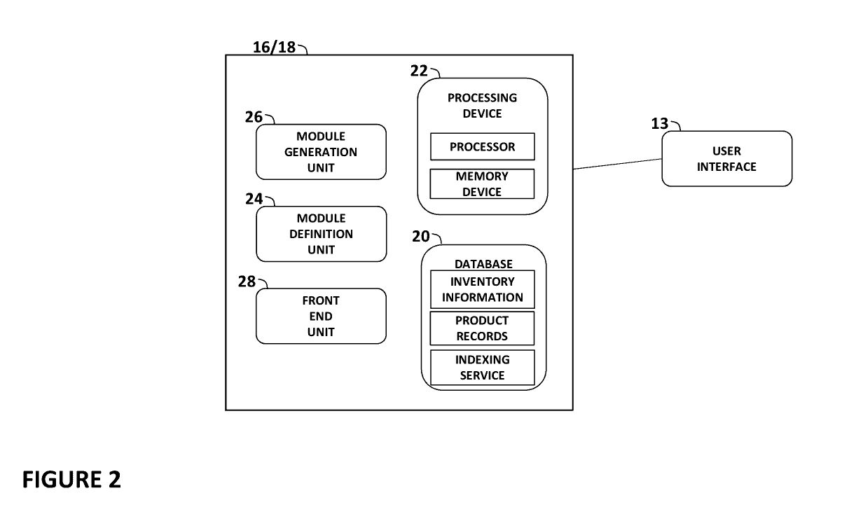

FIG. 3 is a flowchart of a method that may be used with the system shown in FIG. 1, according to an embodiment of the present invention;

FIG. 4 in an illustration of an exemplary screenshot from the system of FIG. 1, according to an embodiment of the present invention;

FIG. 5 in an illustration of an exemplary screenshot from the system of FIG. 1, according to an embodiment of the present invention;

FIG. 6 in an illustration of an exemplary screenshot from the system of FIG. 1, according to an embodiment of the present invention;

FIG. 7 in an illustration of an exemplary screenshot from the system of FIG. 1, according to an embodiment of the present invention;

FIG. 8 in an illustration of an exemplary screenshot from the system of FIG. 1, according to an embodiment of the present invention; and

FIG. 9 in an illustration of an exemplary screenshot from the system of FIG. 1, according to an embodiment of the present invention.

Corresponding reference characters indicate corresponding components throughout the several views of the drawings. Skilled artisans will appreciate that elements in the figures are illustrated for simplicity and clarity and are not necessarily drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION

In the following description, numerous specific details are set forth in order to provide a thorough understanding of the present invention. It will be apparent, however, to one having ordinary skill in the art that the specific detail need not be employed to practice the present invention. In other instances, well-known materials or methods have not been described in detail in order to avoid obscuring the present invention.

Reference throughout this specification to “one embodiment”, “an embodiment”, “one example” or “an example” means that a particular feature, structure or characteristic described in connection with the embodiment or example is included in at least one embodiment of the present invention. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or sub-combinations in one or more embodiments or examples.

Embodiments in accordance with the present invention may be embodied as an apparatus, method, or computer program product. Accordingly, the present invention may take the form of an entirely hardware embodiment, an entirely software embodiment (including firmware, resident software, micro-code, etc.), or an embodiment combining software and hardware aspects that may all generally be referred to herein as a “unit” or “system.” Furthermore, the present invention may take the form of a computer program product embodied in any tangible media of expression having computer-usable program code embodied in the media.

Any combination of one or more computer-usable or computer-readable media (or medium) may be utilized. For example, a computer-readable media may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present invention may be written in any combination of one or more programming languages.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

The flowchart and block diagrams further illustrate the architecture, functionality, and operation of possible implementations of systems, methods, and computer program products according to various embodiments of the present invention. In this regard, each block in the flowchart or block diagrams may represent a segment or portion of code that comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable media that can direct a computer or other programmable data processing apparatus to function in a particular manner, such that the instructions stored in the computer-readable media produce an article of manufacture including instruction means which implement the function/act specified in the flowchart and/or block diagram block or blocks.

Several (or different) elements discussed below, and/or claimed, are described as being “coupled”, “in communication with”, or “configured to be in communication with”. This terminology is intended to be non-limiting, and where appropriate, be interpreted to include without limitation, wired and wireless communication using any one or a plurality of a suitable protocols, as well as communication methods that are constantly maintained, are made on a periodic basis, and/or made or initiated on an as needed basis. The terms “coupled” or “in communication” mean any suitable communications link, including but not limited to the Internet, a LAN, a cellular network or any suitable communications link. The communications link may include one or more of a wired and wireless connection and may be always connected, connected on a periodic basis, and/or connected on an as needed basis.

Selected embodiments of the present invention will now be explained with reference to the drawings. It will be apparent to those skilled in the art from this disclosure that the following description of the embodiments of the present invention is provided for illustration only and not for the purpose of limiting the invention as defined by the appended claims and their equivalents. Referring to the figures, where like numerals generally indicate like or corresponding parts throughout the several views, the systems and methods are constructed in accordance with the invention. With reference to the drawings and in operation, the present invention overcomes at least some of the disadvantages of known systems and methods in the prior art by providing a system and method of module-based organization product-related data for display on a website.

The disclosure particularly describes a system and method for dynamically and algorithmically generating visual representations of product-related data utilized during a user experience on a website. As an example, a user may navigate to a particular website in order to view a set of products. The user may have a general idea of a category of products they wish to review, but would like to have the website generate a plurality of products that fit within that general category. The system, therefore, may be configured to provide the plurality of products for view by the user as a function of that general category. The system may be further implemented to access additional product-related information in order to present a plurality of products that share other common attributes that are not regularly recognized or known by the user of the website.

These visual representations will be addressed throughout the remainder of the disclosure as modules, which are defined as visual groupings of various product-related data points in response to a user interaction with at least one zone on a website. Each module, in turn, is a function of a module definition, which includes at least one common attribute shared by each product-related data point displayed within the module. Each website may contain a list of zones, wherein each zone may contain zero, one or more module definitions (and thus generate the appropriate modules as a response). Modules may also be directly attached to a webpage and not to any zone on a webpage. This will generally apply to websites that may need to adjust to different screen sizes or that adjust to the performance requirements of the system components involved.

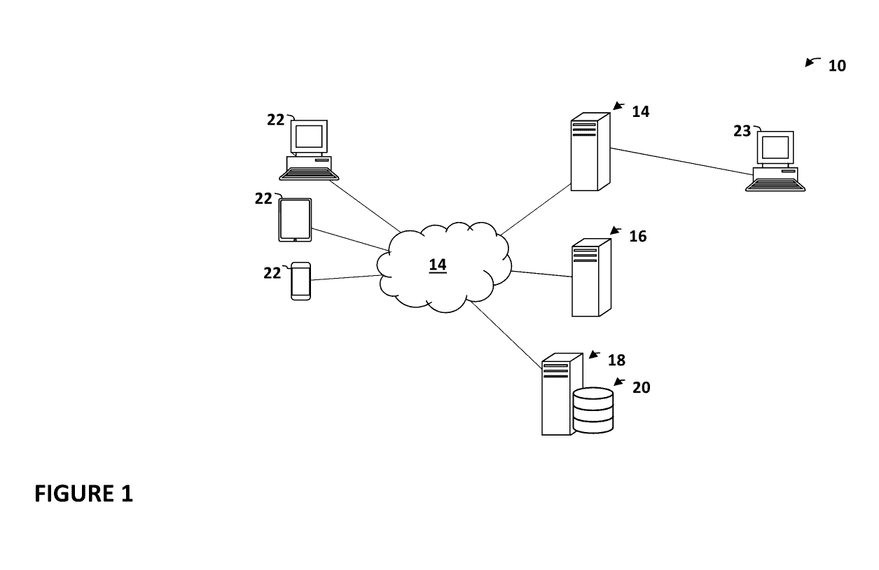

With reference to the figures and in operation, the present invention provides a system, methods and computer product media that facilitates displaying product information to a user via a website. Referring to FIG. 1, an exemplary environment in which the system 10 operates is illustrated. In the illustrated embodiment, the system 10 is configured to enable a user to access a website with one or more user computing devices 12 to view the modules generated by the system via the website.

For clarity in discussing the various functions of the system 10, multiple computers and/or servers are discussed as performing different functions. These different computers (or servers) may, however, be implemented in multiple different ways such as units within a single computer, as nodes of a computer system, etc. . . . The functions performed by the system 10 (or nodes or units) may be centralized or distributed in any suitable manner across the system 10 and its components, regardless of the location of specific hardware. Furthermore, specific components of the system 10 may be referenced using functional terminology in their names. The function terminology is used solely for purposes of naming convention and to distinguish one element from another in the following discussion. Unless otherwise specified, the name of an element conveys no specific functionality to the element or component.

In the illustrated embodiment, the system 10 includes a website hosting server 16, a database server 18, a database 20, and one or more user computing devices 12 that are each coupled in communication via a communications network 14. The communications network 14 may be any suitable connection, including the Internet, file transfer protocol (FTP), an Intranet, LAN, a virtual private network (VPN), cellular networks, etc. . . . , and may utilize any suitable or combination of technologies including, but not limited to wired and wireless connections, always on connections, connections made periodically, and connections made as needed.

The user computing device 12 may include any suitable device that enables a user to access and communicate with the system 10 including sending and/or receiving information to and from the system 10 and displaying information received from the system 10 to a user. For example, in one embodiment, the user computing device 12 may include, but is not limited to, a desktop computer, a laptop or notebook computer, a tablet computer, smartphone/tablet computer hybrid, a personal data assistant, a hand-held mobile device including a cellular telephone, and the like. Each one of the user computing devices 12 may also include a user interface 13, where a user may interact with a website, as well as with the plurality of zones which indicate to the system to request and generate the modules to a user.

By generating modules as a function of the module definitions and product-related data, the system 10 is able to provide a visual representation of product-related data that shares common attributes unknown to the user prior to their interaction with the website. This in turn allows a user to compare and contrast various pieces of previously un-arranged product data in an organized and visual form. The system 10 also allows a website designer/administrator to generate modules that can link various products (and information related to those products) based on common attributes and provide information from databases that were previously unavailable within systems commonly known in the prior art. Furthermore, the system 10 improves the speed and functionality of known computing systems by dynamically generating collections of product-related data, as modules, in response to a user's website interaction in situations that previously required individually programmed user interfaces and data requests. This reduces the use of computing resources during the development, generation and interaction related to a website.

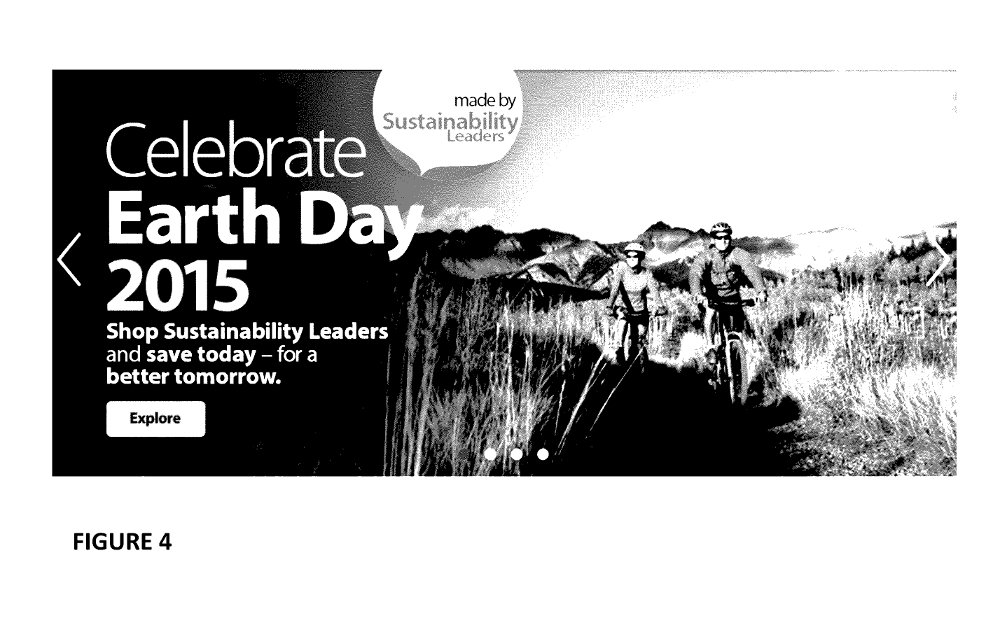

The website hosting server 16 is configured to host a website 26 that is accessible by a user via one or more user computing devices 12. The website hosting server 16 retrieves and stores the modules (shown in FIGS. 4 through 9) associated with one or more websites in response to requests received by the user through the user interface 13 to allow users to interact with the website and search and/or purchase pluralities of products via the website. In one embodiment, the website hosting server 16 is configured to generate and display web pages associated with the website in response to requests being received from consumers via corresponding web browsers that are displayed on the user computing devices 12.

The database server 18 includes a memory device that is connected to at least one database 20 to retrieve and store product-related information contained in the database 20 as a function of the module definitions associated with the zones on the websites. The at least one database 20 contains information associated with a plurality of products that are collected through the system 10 as a function of the module definitions.

In another embodiment within the present disclosure, the at least one database 20 may be a non-relational database. Such non-relational, or “noSQL”, databases allow for the collection and maintenance of data without having to establish common attributes in advance of importing the data into the database. This allows for the use of various types of product-related data without having to pre-define any common attributes within the database 20 itself.

In another embodiment within the present disclosure, the product-related data further includes pricing, inventory, logistical, geographical, audio, video and/or image data. Additional types of data may also be incorporated into the database 20 or incorporated for use by the system 10 through the coupling of additional databases 20.

The processing device 22 executes various programs, and thereby controls components of either the web hosting server 16 or the database server 18 according to user instructions received from the user computing device 12. The processing device 22 may include memory, e.g., read only memory (ROM) and random access memory (RAM), storing processor-executable instructions and one or more processors that execute the processor-executable instructions. In embodiments where the processing device 22 includes two or more processors, the processors can operate in a parallel or distributed manner. In an example, the processing device 22 may execute a module definition unit 24, a module generation unit 26 and a front end unit 28.

The processing device 22 may also include a memory device for storing programs and information in the database 20, and retrieving information from the database 20 that is used by the processor to perform various functions described herein. The memory device may include, but is not limited to, a hard disc drive, an optical disc drive, and/or a flash memory drive. Further, the memory device may be distributed and located at multiple locations.

The module definition unit 24 is configured to provide the module definitions in response to the interactions of the user with the website through any of the various user devices 12. Upon receiving a request for a module definition, the module definition unit 24 will provide the definition in order for the module to be generated with the appropriate data from a database 20. Modules can be algorithmically defined and utilize metrics that are predefined within a database 20, or can be individually created in order to capture information from multiple database simultaneously.

In another embodiment within the present disclosure, the module definition unit 24 further includes at least one module definition wherein the plurality of product-related data elements are individually predefined by a user. These individually configured modules allow a website designer/administrator to generate and display modules containing predefined and sorted data in a particular manner that are geared towards the particular user interaction on the website and in relation to any zone currently involved with that particular interaction. For example, a user's interaction with a particular category of products may cause the website to display a module containing products that are key to that time of year (i.e. barbeque items during a summer holiday weekend/gardening products at the start of Spring). These individually generated modules still incorporate the speed and flexibility afforded to the system 10 while allowing a website designer/administrator the ability to generate pluralities of products that lack a common attribute that is accessible through a database 20.

In another embodiment within the present disclosure, the system 10 further includes a second user interface 23 in communication with the processor. The second user interface 23 is configured to allow a user to individually predefine the plurality of product-related data elements within an individually defined module definition and store the individually defined module definition within the module definition unit. This second user interface 23 provides the access by which a website designer/administrator can establish individual module definitions that are then accessible through the module definition unit 24.

The module generation unit 26 is configured to generate the plurality of modules by collecting the product-related data from at least one database 20 as a function of a module definition forwarded by the module definition unit 24. The module generation unit 26 serves to collect product-related data and services as the link between the at least one database 20 and the rest of the system 10. This ensures that the system 10 can actively interface with multiple unrelated databases 20, while still being able to provide modules in response to user interaction with a website. As such, modules may occur as instances of the module definitions found within the module definition unit 26, allowing the system 10 to generate multiple instances of each module (having the same or different product-related data) depending on the needs of a given website.

The front end unit 28 is configured to collect the queries for module definitions from a user device 12 and coordinate the movement of the module definitions and the modules between the module definition unit 24 and the module generation unit 26 during operation of the system 10. The front end unit 28 may be integrated within the website hosting server 16, as well as further integrated as a component within another embodiment as discussed within this disclosure.

In another embodiment within the present disclosure, the system 10 includes a user interface and a processing device 22 in communication with the user interface. The user interface is accessible to the user and includes at least one zone configured to display a module, the at least one zone having an associated module definition. The module definition comprises a visual organization of a plurality of product-related data elements sharing at least one common attribute. The processing device 22 includes a module definition unit 24 and a module generation unit 26. The module definition unit 24 includes a plurality of module definitions and is configured to provide at least one module definition in response to the presence of the at least one zone on the user interface. The module generation unit 26 is configured to communicate with at least one database 20 including a plurality of product-related data. The module generation unit 26 is configured to generate a module for display within the at least one zone by collecting the product-related data from the database 20 as a function of the module definition and the collected product-related data.

In another embodiment within the present disclosure, the module generation unit 26 sorts the product-related data from the database 20 as a function of the at least one common attribute prior to generation of the module. The module generation unit 26 may incorporate additional sorting and/or manipulation of the various product-related data elements during generation of the module. Such manipulation may be to format the product-related data for compatibility with the module definition and may also dependent on the particular type of data required by the module definition.

In another embodiment within the present disclosure, the user interface is configured to register a user interaction associated with the at least one zone, the module generation unit 26 configured to dynamically generate the associated module as a function of the user interaction. Various zones attached to the user website may require user interactions in order to trigger the request for a module definition and the display of a module. A particular example of this would apply to touch-based interface which may scale additional touch-based interactions into the user interface and generate a more complex interaction between the user and the website.

In another embodiment within the present disclosure, the user interface is further configured to generate a query as a function of the number of zones and the number and types of user interactions on the user interface, the query comprising a plurality of associated module definitions. In order to maintain the speed of system 10, the user interface may bundle all the requested module definitions in order to route them through the system 10 for generation into modules.

In another embodiment within the present disclosure, the processing device further includes a front end unit 28 in communication with the user interface, the module definition unit 24, and the module generation unit 26, the front end unit 28 configured to: receive the query from the user interface; determine the plurality of module definitions within the query; collect the plurality of module definitions from the module definition unit 24; forward the plurality of module definitions from the module definition unit 24 to the module generation unit 26; receive the plurality of modules from the module generation unit 26; and forward the plurality of modules to the user interface. Here, the system 10 now may have a front end unit that operates in managing queries containing multiple module definitions and module instances rather than in particularize code requests and data packets that may be common in other known systems. This significantly increases the speed and efficiency of the system 10 overall by reducing the number of data types that are managed between the user interface 13 and the various system components.

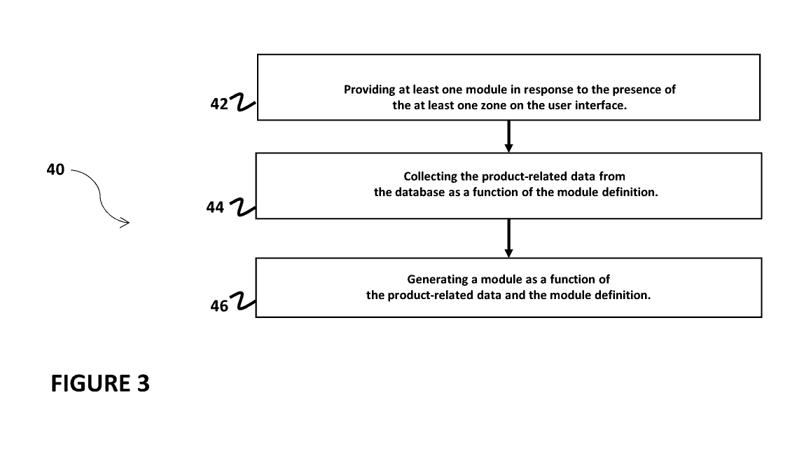

In another embodiment within the present disclosure, as illustrated in FIG. 3, a method 40 of using a system including a user interface and a processing device is provided. The user interface is accessible to the user and includes at least one zone configured to display a module, the at least one zone having an associated module definition. The module definition comprises a visual organization of a plurality of product-related data elements sharing at least one common attribute. The processing device 22 includes a module definition unit 24 and a module generation unit 26. The module definition unit 24 includes a plurality of module definitions. The module generation unit 26 is configured to communicate with the at least database 20. The method 40 includes the steps of: providing 42, through the module definition unit 24, the at least one module definition in response to the presence of the at least one zone on the user interface; collecting 44, through the module generation unit 26, the product-related data from the database 20 as a function of the module definition; and generating 46, through the module generation unit 26, a module for display within the at least one zone as a function of the product-related data and the module definition.

In another embodiment within the present disclosure, the method 40 further includes the step of sorting, through the module generation unit 26, the product-related data from the database 20 as a function of the at least one common attribute prior to the generation of the module.

In another embodiment within the present disclosure, the method 40 further including the steps of: registering, through the user interface, a user interaction associated with the at least one zone and dynamically generating, through the module generation unit 26, the associated module as a function of the user interaction.

In another embodiment within the present disclosure, the system further includes a second user interface in communication with the processor and the method 40 further includes the steps of allowing, through the second user interface, a user to individually predefine the plurality of product-related data elements within a module definition and storing the individually defined module definition within the module definition unit 24.

In another embodiment within the present disclosure, the method 40 further includes the step of generating, through the user interface, a query as a function of the number of zones and the number and types of user interactions on the user interface with the query comprising a plurality of associated module definitions.

In another embodiment within the present disclosure, the processing device further includes a front end unit 28 in communication with the user interface, the module definition unit 24, and the module generation unit 26, the method 40 further including the steps of: receiving, through the front end unit 28, the query from the user interface; determining, through the front end unit 28, the plurality of module definitions within the query; collecting, through the front end unit 28, the plurality of module definitions from the module definition unit 24; forwarding, through the front end unit 28, the plurality of module definition from the module definition unit 24 to the module generation unit 26; receiving, through the front end unit 28, the plurality of modules from the module generation unit 26; and forwarding, through the front end unit 28, the plurality of modules to the user interface. In another embodiment within the present disclosure, the at least one database 20 is a non-relational database. In another embodiment within the present disclosure, the product-related data further includes pricing, inventory, logistical, geographical, audio, video and/or image data.

In another embodiment within the present disclosure, a non-transitory information recording medium on which a computer readable program is recorded that causes a computer to function as a system is provided. The system 10 includes a user interface and a processing device in communication with the user interface. The user interface is accessible to the user and includes at least one zone configured to display a module, the at least one zone having an associated module definition. The module definition comprises a visual organization of a plurality of product-related data elements sharing at least one common attribute. The processing device 22 includes a module definition unit 24 and a module generation unit 26. The module definition unit 24 includes a plurality of module definitions and is configured to provide at least one module definition in response to the presence of the at least one zone on the user interface. The module generation unit 26 is configured to communicate with at least one database 20 including a plurality of product-related data. The module generation unit 26 is configured to generate a module for display within the at least one zone by collecting the product-related data from the database 20 as a function of the module definition and the collected product-related data.

FIGS. 4 through 9 illustrate various module embodiments based on the system 10 described within the disclosure. The various module embodiments represent different ways in which both module definitions and data types can be functionally streamlined for display based on a user interaction with a website.

FIG. 4 represents an individualized module based on custom data elements. Such a module would be utilized by website administrators in order to place custom products or announcement within a specific zone on a web site by incorporating images and information through the secondary user interface 23. For example, this module type would allow the website administrator or designer to incorporate seasonal advertisements through the system 10 without additional effort or mistakes.

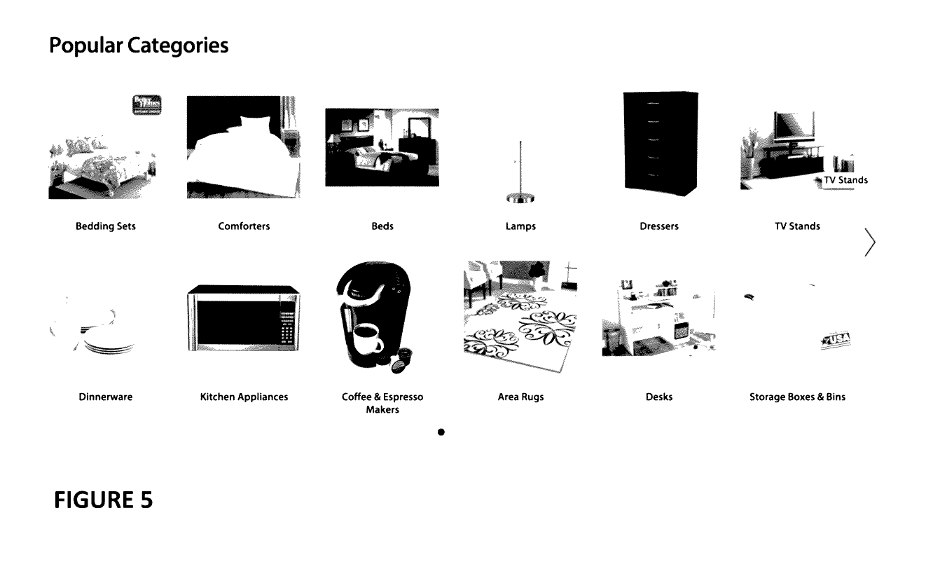

FIG. 5 illustrates a “Popular Categories” module to show common product listings on the website. Such a module could be generate multiple times on a website in order to show a user multiple category types based on their interaction on the website. Additional categories modules could highlight brands, category sub-items or any other comparative attribute that provided a user with choices but did not require product-specific information.

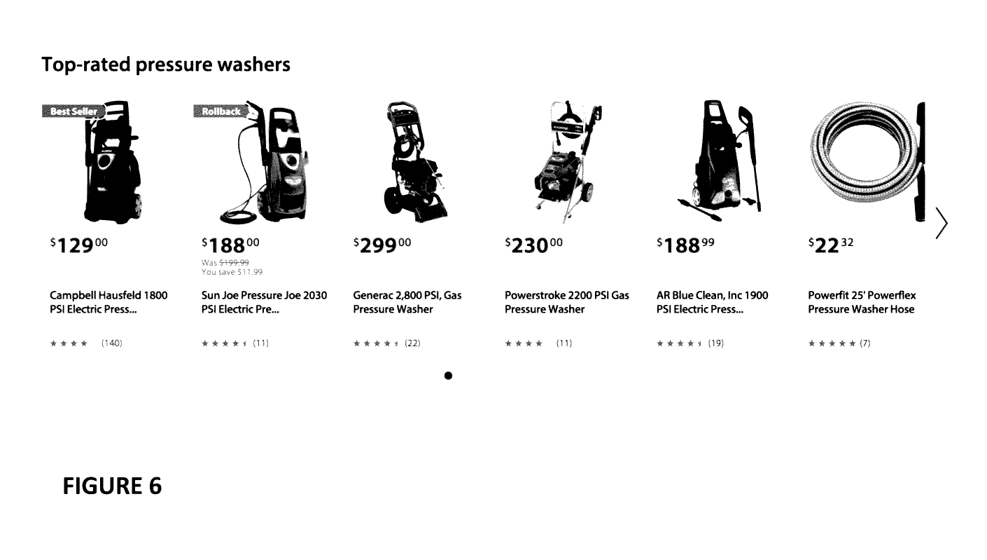

FIG. 6 illustrates a module with a listing of items within a particular item category. This type of module may be used multiple time as a user interacts with a website and as such using this module through the system 10 would greatly increase uniformity on the design and programming of the website as well as shopping uniformity and appeal for a user.

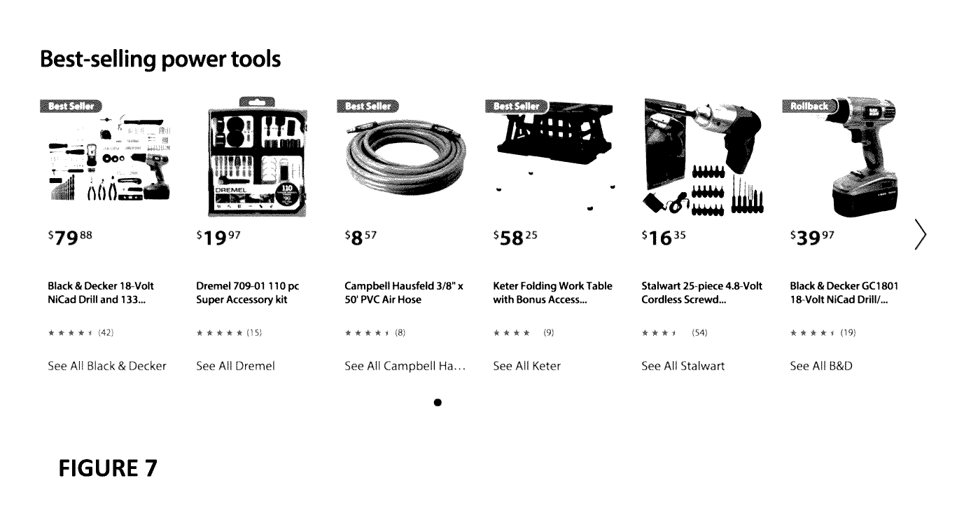

FIG. 7 illustrates a module that groups items by facets and shows a representative item of for each group shown within the module. The objective of this module is to emulate the experience of a shelf to a customer and providing products within various sub-categories within a given category. This allows a customer additional shopping options as they navigate a website.

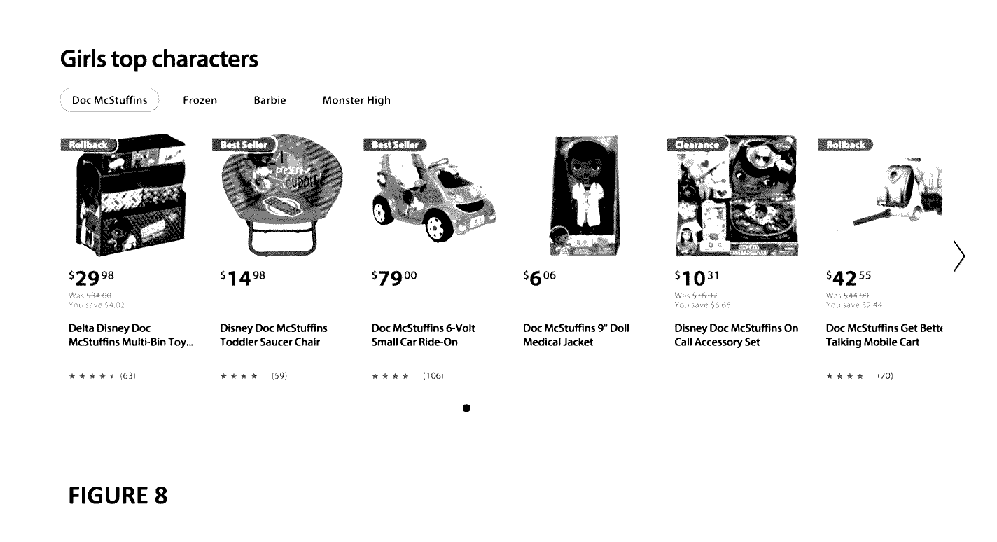

FIG. 8 illustrates a module that incorporates the facet element above but also allows a user to interact with the module in order to sort items within the module on their own. In this example, the rounded product keywords above the products allows the customer to sort the items by the given keywords. This can be further expanded in to include other sorting mechanisms as well as additional functionality within the module instance.

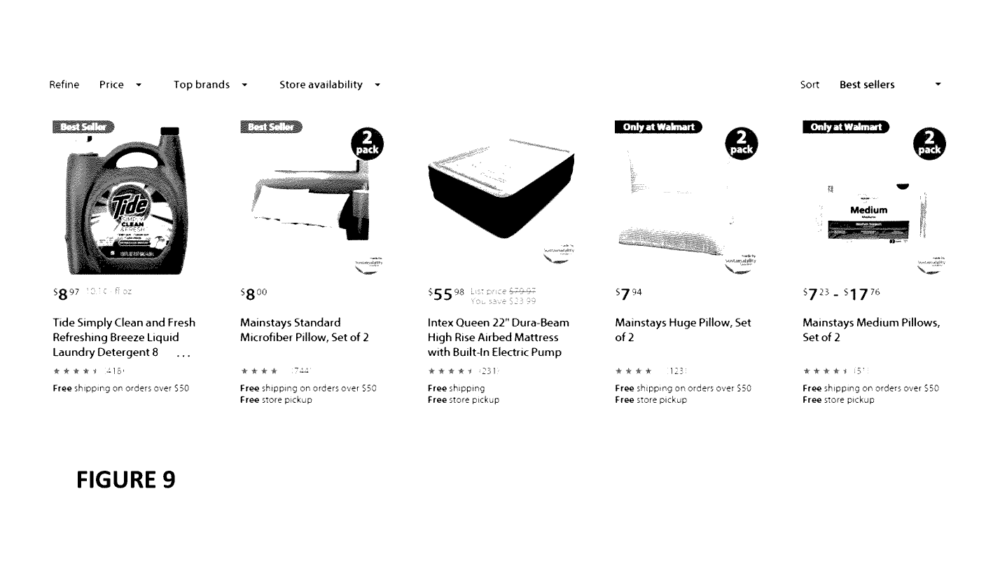

Finally, FIG. 9 illustrates a module that further incorporates product metadata into each product listing. For example, each product in this module indicates shipping and in-store pickup options along with each product listing. This illustrates a module that incorporates information from different and separate databases 20 in order to generate the visual representation of the products within the module.

Exemplary embodiments of these systems and methods are described above in detail. The systems and methods are not limited to the specific embodiments described herein, but rather, components of the systems and/or steps of the methods may be utilized independently and separately from other components and/or steps described herein. For example, the systems may also be used in combination with other systems and methods, and is not limited to practice with only the system and method as described herein.

The processing device 22 and likewise any computing device, or computer, such as described herein, may include at least one or more processors or processing units and a system memory. The gaming controller may typically also include at least some form of computer readable media. By way of example and not limitation, computer readable media may include computer storage media and communication media. Computer storage media may include volatile and nonvolatile, removable and non-removable media implemented in any method or technology that enables storage of information, such as computer readable instructions, data structures, program modules, or other data. Communication media typically embody computer readable instructions, data structures, program modules, or other data in a modulated data signal such as a carrier wave or other transport mechanism and include any information delivery media. Those skilled in the art should be familiar with the modulated data signal, which has one or more of its characteristics set or changed in such a manner as to encode information in the signal. Combinations of any of the above are also included within the scope of computer readable media.

The order of execution or performance of the operations in the embodiments of the invention illustrated and described herein is not essential, unless otherwise specified. That is, the operations described herein may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

In some embodiments, a processor, as described herein, includes any programmable system including systems and microcontrollers, reduced instruction set circuits (RISC), application specific integrated circuits (ASIC), programmable logic circuits (PLC), and any other circuit or processor capable of executing the functions described herein. The above examples are exemplary only, and thus are not intended to limit in any way the definition and/or meaning of the term processor.

In some embodiments, a database, as described herein, includes any collection of data including hierarchical databases, relational databases, flat file databases, object-relational databases, object oriented databases, and any other structured collection of records or data that is stored in a computer system. The above examples are exemplary only, and thus are not intended to limit in any way the definition and/or meaning of the term database. Examples of databases include, but are not limited to only including, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, Calif.; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.)

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Other aspects and features of the present invention may be obtained from a study of the drawings, the disclosure, and the appended claims. The invention may be practiced otherwise than as specifically described within the scope of the appended claims. It should also be noted, that the steps and/or functions listed within the appended claims, notwithstanding the order of which steps and/or functions are listed therein, are not limited to any specific order of operation.

Although specific features of various embodiments of the invention may be shown in some drawings and not in others, this is for convenience only. In accordance with the principles of the invention, any feature of a drawing may be referenced and/or claimed in combination with any feature of any other drawing.

What is claimed is:

1. A system comprising:
a user interface accessible to a user including at least one zone configured to display a module, the at least one zone having an associated module definition comprising a visual organization of a plurality of product-related data elements sharing at least one common attribute; and
a processing device in communication with the first user interface, the processor including:
a module definition unit including a plurality of module definitions and being configured to provide at least one module definition in response to the presence of the at least one zone on the user interface; and
a module generation unit being configured to communicate with at least one database, the database including a plurality of product-related data, and to generate a module for display within the at least one zone by collecting the product-related data from the database as a function of the module definition and the collected product-related data.

2. The system of claim 1, the module generation unit being configured to sort the product-related data from the database as a function of the at least one common attribute prior to generation of the module.

3. The system of claim 1, the user interface being configured to register a user interaction associated with the at least one zone, the module generation unit being configured to dynamically generate the associated module as a function of the user interaction.

4. The system of claim 1, the module definition unit further including at least one module definition wherein the plurality of product-related data elements are individually predefined by a user.

5. The system of claim 4, the system further including a second user interface in communication with the processing device, the second user interface configured to allow a user to individually predefine the plurality of product-related data elements within a individually defined module definition and store the individually defined module definition within the module definition unit.

6. The system of claim 3, the user interface further configured to generate a query as a function of the number of zones and the number and types of user interactions on the user interface, the query comprising a plurality of associated module definitions.

7. The system of claim 6, the processing further including a front end unit in communication with the user interface, the module definition unit and the module generation unit, the front end unit configured to:
receive the query from the from user interface;
determine the plurality of module definitions within the query;
collect the plurality of module definitions from the module definition unit;
forward the plurality of module definitions from the module definition unit to the module generation unit;
receive the plurality of modules from the module generation unit; and
forward the plurality of modules to the user interface.

8. The system of claim 1, wherein the at least one database is a non-relational database.

9. The system of claim 1, wherein the product-related data further includes pricing, inventory, logistical, geographical, audio, video and/or image data.

10. A method utilizing a system including a user interface and processing device in communication with the user interface including at least one zone configured to display a module, the at least one zone having an associated module definition, the module definition comprising a visual organization of a plurality of product-related data elements sharing at least one attribute, the processor including a module definition unit having at least one module definition and a module generation unit, the module generation unit configured to communicate with at least one database, the database including a plurality of product-related data, the method including the steps of:
providing, through the module definition unit, the at least one module definition in response to the presence of the at least one zone on the user interface;
collecting, through the module generation unit, the product-related data from the database as a function of the module definition;
generating, through the module generation unit, a module for display within the at least one zone as a function of the product-related data and the module definition.

11. The method of claim 10, the method further including the step of sorting, through the module generation unit, the product-related data from the database as a function of the at least one common attribute prior to the generation of the module.

12. The method of claim 10, the method further including the steps of:
registering, through the user interface, a user interaction associated with the at least one zone; and
dynamically generating, through the module generation unit, the associated module as a function of the user interaction.

13. The method of claim 10, the module definition unit further including at least one module definition wherein the plurality of product-related data elements are individually predefined by a user.

14. The process of claim 13, the system further including a second user interface in communication with the processing device, the method further including the steps of allowing, through the second user interface, a user to individually predefine the plurality of product-related data elements within a module definition and storing the individually defined module definition within the module definition unit.

15. The method of claim 12, the method further including the step of generating, through the user interface, a query as a function of the number of zones and the number and types of user interactions on the user interface, the query comprising a plurality of associated module definitions.

16. The method of claim 15, the processing device further including a front end unit in communication with the user interface, the module definition unit, and the module generation unit, the method further including the steps of:
receiving, through the front end unit, the query from the from user interface;
determining, through the front end unit, the plurality of module definitions within the query;
collecting, through the front end unit, the plurality of module definitions from the module definition unit;
forwarding, through the front end unit, the plurality of module definition from the module definition unit to the module generation unit;
receiving, through the front end unit, the plurality of modules from the module generation unit; and
forwarding, through the front end unit, the plurality of modules to the user interface.

17. The method of claim 10, wherein the at least one database is a non-relational database.

18. The method of claim 10, wherein the product-related data further includes pricing, inventory, logistical, geographical, audio, video and/or image data.

19. A non-transitory information recording medium on which a computer readable program is recorded that causes a computer to function as a system comprising:
a user interface accessible to a user including at least one zone configured to display a module, the at least one zone having an associated module definition, the module definition comprising a visual organization of a plurality of product-related data elements sharing at least one common attribute; and
a processing device in communication with the first user interface, the processor including:
a module definition unit including a plurality of module definitions and being configured to provide at least one module definition in response to the presence of the at least one zone on the user interface; and
a module generation unit being configured to communicate with at least one database, the database including a plurality of product-related data, and to generate a module for display within the at least one zone by collecting the product-related data from the database as a function of the module definition and the collected product-related data.
